(19) United States
(12) Patent Application Publication
(10) Pub. No.: US 2015/0095315 A1
(43) Pub. Date: Apr. 2, 2015

(54) INTELLIGENT DATA REPRESENTATION PROGRAM

(71) Applicant: Trial Technologies, Inc., Philadelphia, PA (US)

(72) Inventors: James DeCrescenzo, Cherry Hill, NJ (US); Matthew McElvenny, Philadelphia, PA (US)

(21) Appl. No.: 14/501,925

(22) Filed: Sep. 30, 2014

Related U.S. Application Data
(60) Provisional application No. 61/885,262, filed on Oct. 1, 2013.

(51) Int. Cl. G06F 17/30; G06F 3/0487; G06F 3/0481

(52) U.S. Cl. CPC G06F 17/30554; G06F 17/30091; G06F 17/30424; G06F 3/04817; G06F 3/0487
USPC 707/722

(57) ABSTRACT

Organizing, visualizing, and manipulating data stored in a database using computer interaction techniques is provided. Motion-aware sensors, multi-touch monitors, and/or user input devices may be used with the various embodiments to allow users to interact with a collection of data comprised of a plurality of datasets in a three-dimensional environment. Using gestures or other selection inputs, a user may select groups of datasets. The selected datasets become a subset of data and inhabit a section of a three-dimensional representation of the collection of data, each dataset represented by an icon in the 3D representation. Subsets may be manipulated and/or annotated separately from the overall collection of data. Toolsets are provided that allow commands made in subsets to apply to the overall collection of data or to the subsets. A billboard toolbox is activated when an icon is selected, providing a text box populated with information about the selected icon.

### CROSS-REFERENCE TO RELATED APPLICATIONS

This application claims priority to U.S. Provisional Application Ser. No. 61/885,262 filed Oct. 1, 2013, which is incorporated herein by reference in its entirety.

### TECHNOLOGY FIELD

The present disclosure relates generally to database management, and more particularly to a program that manages and provides a representation of data contained in a database.

### BACKGROUND

It is desirable for a user to have the ability to sort, view, and otherwise manipulate data, which may be in the form of documents or files, stored in a database. Current database management utilizes two-dimensional technology requiring keyboard and mouse interactions from a user. For example, a mouse may be used to highlight documents, while information may be entered through a keyboard. When sets of documents are created, they exist as an array of documents, and usually populate lists, boxes, or other tables. Datasets can be transposed into charts and graphs, but these graphs are two-dimensional and are mainly used for visualizing trends rather than working with the documents themselves. Fields may be sorted and the documents can re-sort themselves, but even if sorted based on date, since the documents are presented in a list view, the documents lack a spatial component to their presentation; for example, two documents separated in time by a year are physically as close together as documents separated by minutes. The platforms that organize data into graphs or charts to demonstrate relationships merely provide a way to view datasets, not the whole universe of data, nor do they provide smart toolsets for further manipulating that data.

Thus, a database management program for importing, sorting, displaying, and annotating data is desired.

### SUMMARY

Embodiments provide a method of managing data in a database and a method of providing a time-ordered representation of data in a database.

In an embodiment, a method of managing data in a database comprises: obtaining a collection of data comprised of a plurality of datasets; storing the plurality of datasets in a database; associating each of the plurality of datasets with one or more metadata fields; sorting a subset of the collection of data by ordering corresponding ones of the plurality of datasets according to at least one of the one or more metadata fields; providing a representation of the subset of the collection of data based on the ordering of the corresponding ones of the plurality of datasets, wherein the representation comprises a three-dimensional representation, wherein each of the corresponding ones of the plurality of datasets is represented by an icon in the representation; and providing an altered representation of the subset of the collection of data based on received user-based commands to the representation.

In some embodiments, the subset of the collection of data is selected based upon at least one of (i) a selected one or more of the plurality of datasets; and (ii) a selected one or more of the one or more metadata fields.

In some embodiments, the three-dimensional representation comprises a time and date-ordered grid of the icons of the corresponding ones of the plurality of datasets. The time and date-ordered grid may comprise a calendar view of the icons of the corresponding ones of the plurality of datasets.

According to an embodiment, the user-based commands comprise an action to one or more of move, rotate, resize, and zoom the representation to provide the altered representation. The action may comprise one or more of a gesture command, a voice command, a touch command, a mouse command, and a keyboard command.

According to an embodiment, the metadata fields comprise one or more of time, date, author, subject, and identification number.

In some embodiments, the icons are interactive, wherein interaction with a particular icon provides one or more of additional information and an additional representation associated with the particular icon to be provided.

The method of managing data in a database may further comprise: providing one or more toolsets within a portion of at least one of the representation and the altered representation, the one or more toolsets providing information and actions associated with at least one of the subset of the collection of data and the user-based commands.

In another embodiment, a method of providing a time-ordered representation of data in a database is provided. The method comprises: obtaining a collection of data comprised of a plurality of datasets; storing the plurality of datasets in a database; associating each of the plurality of datasets with an associated time field; sorting a subset of the collection of data by ordering corresponding ones of the plurality of datasets according to the associated time fields; and providing a three-dimensional time and date-ordered representation of the subset of the collection of data based on the ordering of the corresponding ones of the plurality of datasets, wherein each of the corresponding ones of the plurality of datasets is represented by an icon in the representation.

The method of providing a time-ordered representation of data in a database may further comprise: providing an altered representation of the subset of the collection of data based on received user-based commands to the representation.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIGS. 1A-1F are exemplary three-dimensional representations of a collection of data, according to various embodiments;

FIG. 2 provides an exemplary data input representation flowchart, according to an embodiment;

FIGS. 3-7 provide flowcharts illustrating user interaction features of the data representation program, according to various embodiments; and

FIG. 8 is an exemplary representation of a computing environment used in embodiments provided herein.

### DETAILED DESCRIPTION

Embodiments provide a method of and a program for organizing, visualizing, and manipulating data stored in a database using computer interaction techniques, such as touch, gesture, motion-aware sensors, and voice commands. Various embodiments are directed to importing, sorting, displaying, and annotating data, such as emails, documents, and videos. Motion-aware sensors and/or multi-touch monitors may be used with the various embodiments to allow users to interact with a collection of data comprised of a plurality of datasets in a three-dimensional environment. A keyboard or mouse or other user input device may also be used.

Hereinafter, a collection of data refers to a plurality of datasets or data, such as files, documents, videos, images, emails, and the like. Datasets are imported and stored in a database. A user may interact with individual datasets, using, for example, touch or motion gestures. Interacting with an individual dataset may cause that dataset to open and provide controls specific to the selected type of dataset.

According to an embodiment, using gestures or other selection inputs (e.g., voice or user-input devices), a user may select groups of datasets based upon search criteria. The selected datasets become a subset of data and inhabit a section of a three-dimensional (3D) representation of the collection of data, provided to a user on a graphical user interface (GUI). According to an embodiment, subsets may be manipulated and/or annotated separately from the overall collection of data. According to an embodiment, tool sets are provided that allow commands made in subsets to apply to the overall collection of data.

As the user navigates the overall collection of data in the 3D representation, toolbar windows may be populated with the most used or useful toolsets depending on the volume and/or type of data visible on the screen. These toolbars provide the ability to interact with the datasets.

Users are able to view datasets, run searches for datasets, highlight the results in the visible collection of data, and create subsets of data, through the use of gesture-controls, spoken commands, user-input devices, or a combination thereof.

In one embodiment, datasets are indexed and arranged in a 3D representation incorporating a time-date-based grid into which the datasets receive a position based upon the time that the dataset was created. Using motion or touch technology, for example, the user navigates through the universe of these datasets. Individual datasets may appear as icons in a collection of data. Relationship lines may be provided between linked or associated datasets, depending on the criteria the user selects; for example, all documents sent by a specific individual. Moreover, in one embodiments, by selecting a dataset, all related datasets may highlight themselves depending on search criteria selected by the user; for example, all documents with “Draft Agreement” in the metadata or by allowing a comment field to be filled on a specific dataset, or applying topic-related flags to a subset of datasets.

According to an embodiment, information (e.g., the collection of data) stored in a database is organized in a 3D grid in date and time order. In one embodiment, the organization of the datasets may be envisioned as a loaf of bread or a cube. Looked at from the front of the loaf or cube, datasets are organized by day of the month (e.g., day 1 is top left, day 7 is top right, day 8 is below day 1, day 14 is below day 7, etc.). Turning and looking at the loaf or cube from the side, each slice of the loaf or cube is a month. With the most recent month on the right hand side, a month earlier is the next slice to the left; or the most recent month may be on the left hand side with the preceding month being to the right. With twelve slices per year, the following or preceding year earlier would be another loaf or cube, in one embodiment. A user can use touch or motion gestures to move, rotate, resize, and zoom through the grid. When looked at head-on, the grid resembles a calendar with seven columns of dataset blocks (e.g., Sunday on the left, Saturday on the right; or the first day of the month on the top left and the seventh day on the top right). The main display area may be manipulated using a multi-touch, gesture or voice recognition device, or other user-input devices (e.g., mouse, keyboard). Using these devices, the user changes the view of the datasets as presented to the user on the GUI.

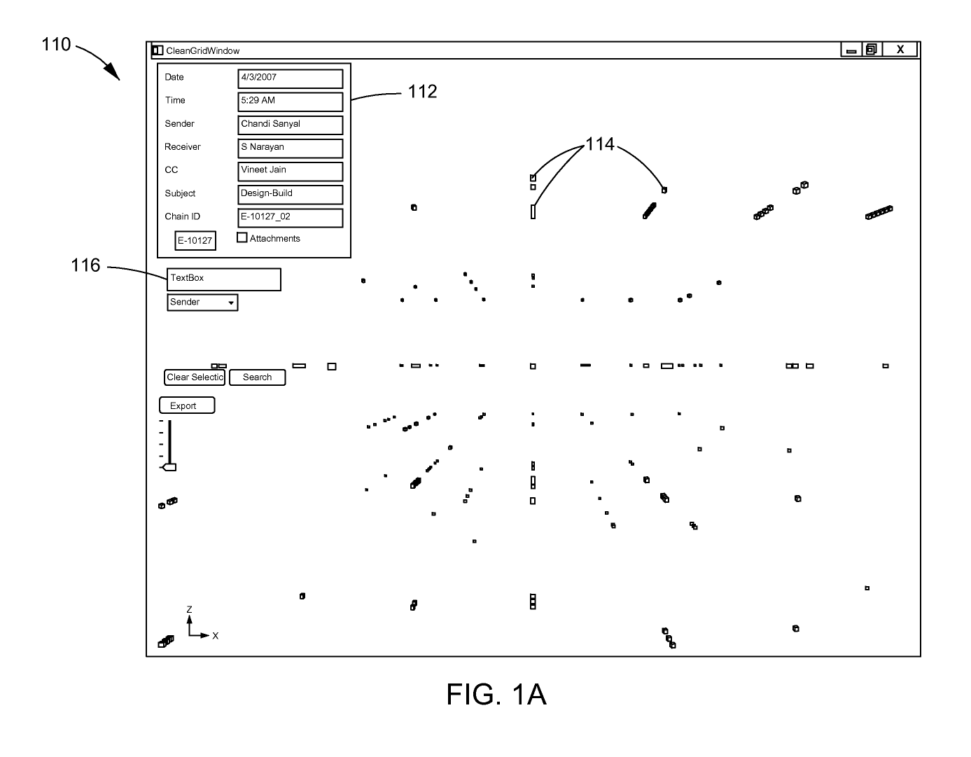

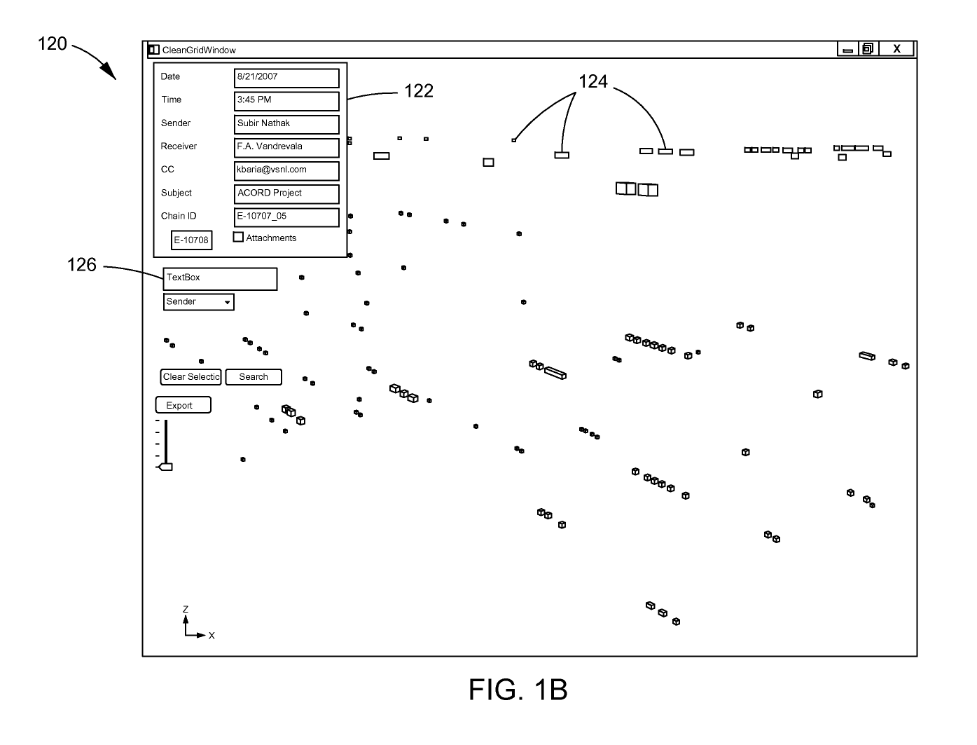

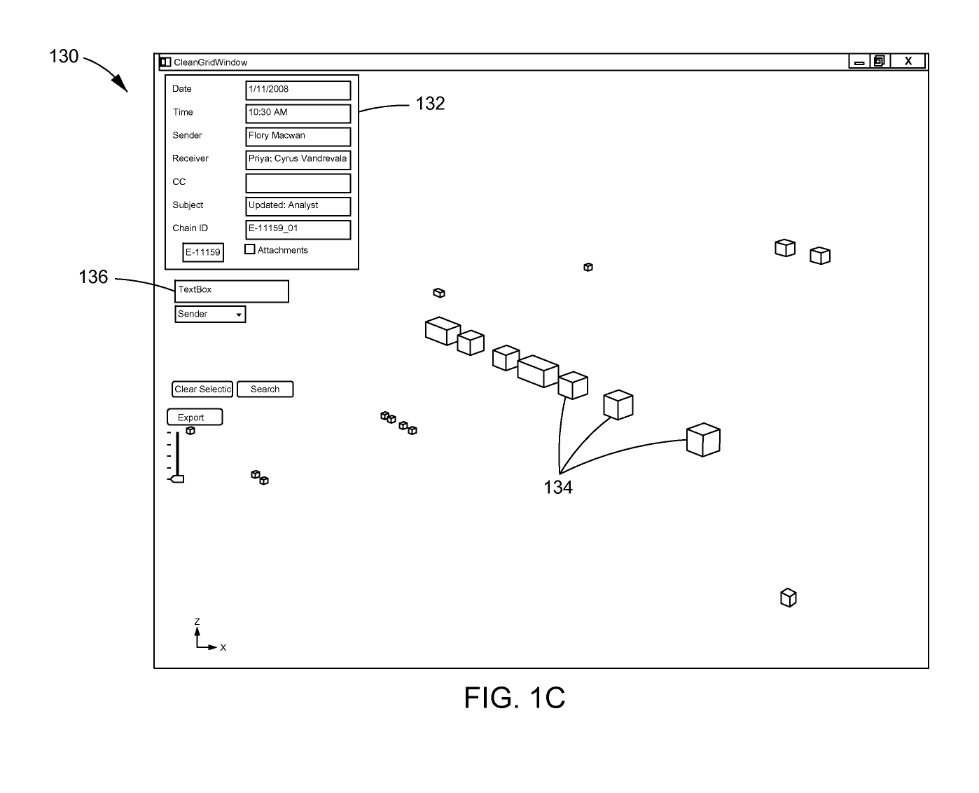

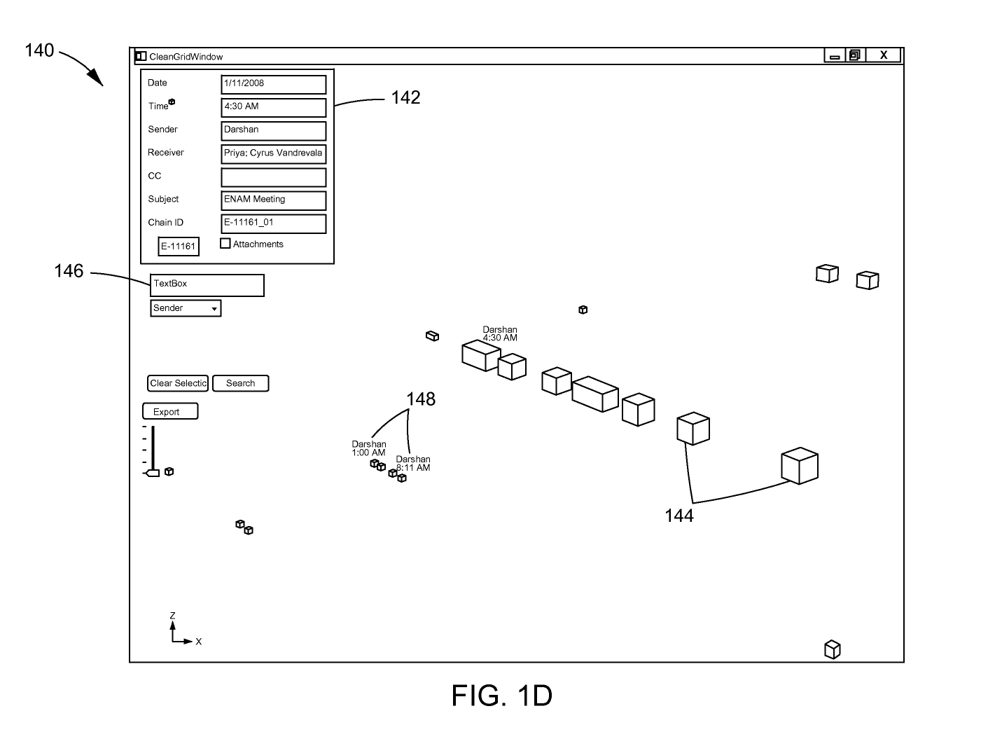

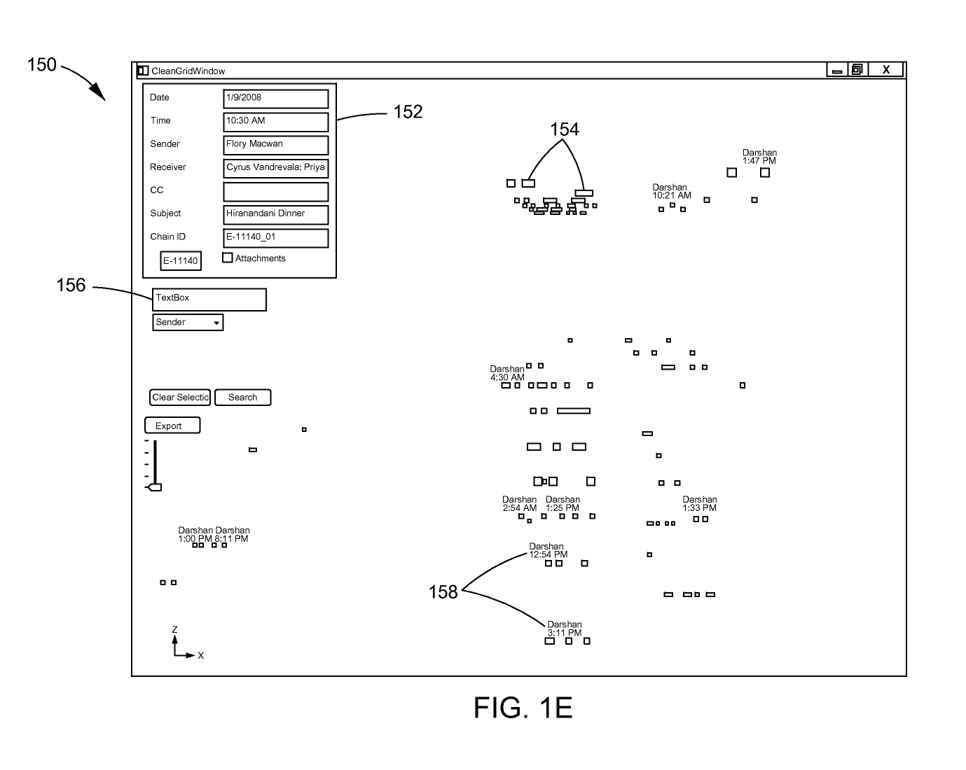

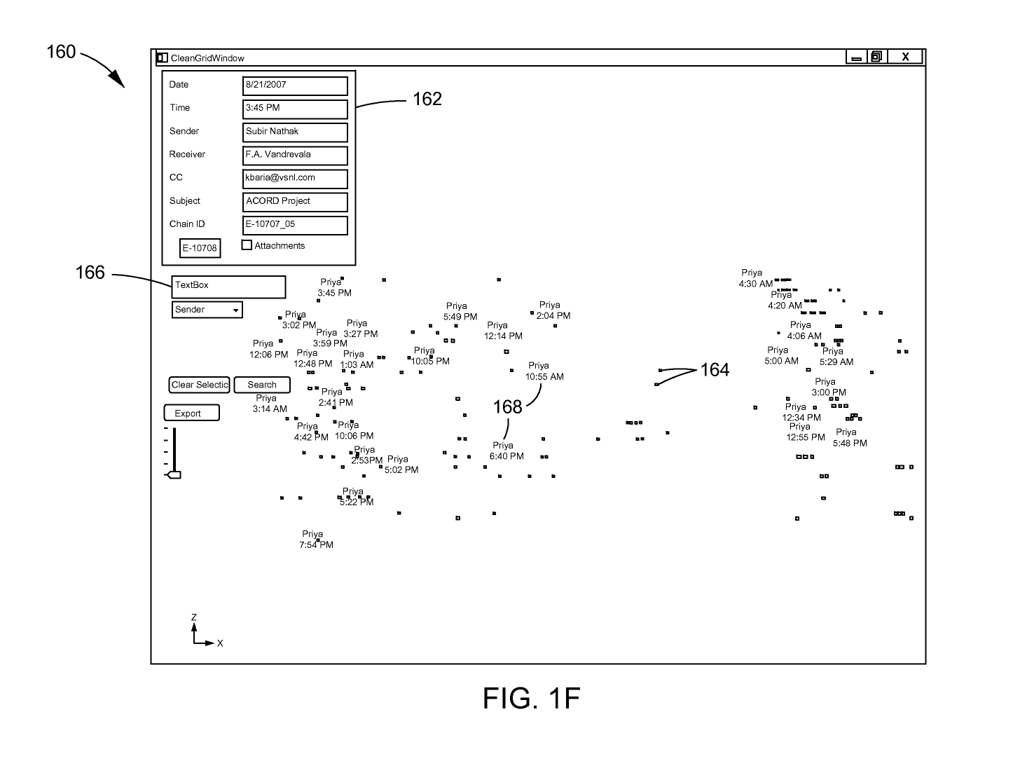

FIGS. 1A-1F illustrate exemplary three-dimensional representations of a collection of data, according to various embodiments. Shown in FIGS. 1A-1F are a plurality of exemplary 3D representations 110, 120, 130, 140, 150, and 160. Each 3D representation includes one or more toolset windows 112, 122, 132, 142, 152, and 162; one or more icons 114, 124, 134, 144, 154, and 164; one or more textboxes 116, 126, 136, 146, 156, and 166; and one or more billboard textboxes 118, 128, 138, 148, 158, and 168; each of which is described below in further detail.

Changing the position of a user camera for viewing the datasets changes the way information is perceived in a variety of ways on the 3D representation. Selecting from a dropdown box in a toolset window 112, 122, 132, 142, 152, or 162 allows the user to view connected documents in a different color or connected via lines. For example, viewing the datasets head-on, provides the user with a calendar-like grid view, as shown in an exemplary embodiment in FIG. 1A with 3D representation 110. The box at the top left of the image is an email (or other dataset) from the first day of the month; the box next to that is an email from the second day of the month, and so on until day 7 at the extreme top right and day 8 directly under day 1 on the z axis. Thus, at a glance, the user can see on which days emails were sent. Refining search criteria, the user is able to see in a glance when a subject first came up, when someone was included on emails, when attachments were sent, and other desired pieces of information relating to the datasets. The search criteria is inputted or adjusted through selection fields in the toolset window 112, 122, 132, 142, 152, or 162. According to an embodiment, the information available in a toolset window 112, 122, 132, 142, 152, or 162 is context-based, offering different choices of tools via the selection fields based on the selected datasets.

FIG. 1B provides a perspective view of the same set of emails in a 3D representation 120. In FIG. 1B, some emails appear to be in a tight line; these emails are arranged by hour in that day.

Icons

Once datasets are inputted (described in detail below), the data representation program generates a corresponding icon 114, 124, 134, 144, 154, or 164 and places it in the 3D representation 110, 120, 130, 140, 150, or 160. In the case of multiple emails comprising a chain, the emails may be linked with a line drawn between them or a change in color, for example.

According to an embodiment, each icon has an atmosphere or region of the 3D representation. In some embodiments, when a user camera approaches an icon and is within a certain pre-defined distance of the icon (i.e., “enters its atmosphere”), controls available to the user will supplement themselves with controls specific to annotating and working with a single dataset represented by the approached icon, such as the ability to read the text of the dataset, highlight and annotate the text of the dataset, or make page-specific comments, for example. Users may be able to quickly navigate to an icon by “grabbing” and “pulling” on it through gesture-based or voice-based commands, for example. Once a user moves away or backs away from an icon, the icon (and its associated data) will close.

The icons may, in some embodiments, be interactive. The user may interact with the data grid by using motion-aware or touch gestures. For instance, a motion-aware gesture such as taking both palms together, then pulling them apart in an ‘open’ gesture may zoom the user in through the collection of data. The opposite gesture may zoom out. Clicking, touching, or otherwise interacting with an icon may cause various actions to occur. For example, clicking on an icon representing an email may cause every email sent by the same individual to change color at the same time, brighten a line connecting emails in the same string, and cause those emails with attachments to glow more brightly in the chain. The user may make a gesture to open the icon and reveal the text and the scanned image of the associated dataset. Inside the icon, other tools, including but not limited to a highlighter, a comment field and other data processing fields, may be present. If the email has an attachment, the attachment may have an icon which a user may open to reveal the text of that document.

When an icon opens, the metadata associated with the dataset may be present in part of the opened icon. A user may select one or more of the fields to use as search terms to browse the rest of the icons in the collection of data or a subset of data.

According to an embodiment, a billboard 118, 128, 138, 148, 158, or 168 is a text box that appears over or near a respective icon 114, 124, 134, 144, 154, or 164. When an icon is tapped or highlighted, that icon's billboard activates and is populated with metadata from the icon. In some embodiments, the metadata shown may be the name of the sender of the email and the email date associated with the icon, or the author of a letter and a date. This information can be flexible, so if, for example, a user is searching for a person who received an email, the email's receiver can populate the billboard. The information populated in the billboard 118, 128, 138, 148, 158, or 168 may be selected by the textbox 116, 126, 136, 146, 156, or 166. The textboxes 116, 126, 136, 146, 156, and 166 work with the billboards 118, 128, 138, 148, 158, and 168, to allow a user to make selections with respect to the information provided in the billboards 118, 128, 138, 148, 158, and 168 (e.g.,

FIGS. 1C and 1D provide a perspective view of a 3D representation 130 and 140, respectively, of a collection of data or a subset of a collection of data in which the data is represented with icons 134 and 144.

In one example, an icon may represent all of the pictures taken by an expert at a site inspection. By opening that icon, the user is able to browse the pictures, re-order or sort the pictures, and assign notes or comments to one or more of the pictures. A user may also be able to edit (such as crop, brighten, contrast) the photos with basic editing tools. Individual pictures may be selected and added to a subset for printing or later display, for example.

In another example, an icon may represent a letter enclosing an expert report. The report may have an icon associated with it. The icons may be linked, with the report as a subset of the letter; or, if the user rearranges the order, the letter may be a subset icon of the report. Attachments to the expert report, such as charts, graphs, spreadsheets, tables, or photos, may be individually marked as subset icons under the report.

In yet another example, an icon may represent a video-taped deposition. Opening that icon allows the user to see and play the deposition. The transcript may be linked to the video. The user is able to browse, search, annotate, and comment on the transcript. Highlighting text may allow the user to make clips from the video. The user may be presented with an option of adding that clip to a subset for copying or later display. Selecting a video deposition icon may allow the user to highlight all other video depositions in the collection of data. By highlighting a section of the transcript, the user may have an option to search the other video transcripts for any search criteria. The user may also be able to search the entire database for that criteria, including document OCR (optical character recognition) data and self-generated comments.

The user may create a collection of data points (data collection or subset of data) by selecting one or more icons. The user may use motion-aware and/or touch gestures such as grabbing one of the selected icons and tossing it in a direction. Once a subset of data has been identified within the program by a method, such as grab and toss, the data points may duplicate themselves. They may then slide or move to a separate part of the grid or representation. The documents in this subset of data may then be worked on or viewed individually. A subset of data may be desirable to reduce the number of unrelated documents that may otherwise clutter the patterns that would be visible in the subset. A user may have the option at any time while working in a subset to include or note the collection of data in search requests.

FIG. 1E shows a view of emails sent by one individual in a series in a perspective view of a 3D representation 150. FIG. 1F shows a pulled-back view of 2008 and 2007 at the same time, again from the side, in a 3D representation 160. With a glance, the user is able to see a flurry of emails sent by this user in the first quarter of 2007, reduced activity the rest of the year, and a flurry in the first two months of 2008.

Toolsets

According to various embodiments, surrounding the edge of the representation is one or a series of toolset windows 112, 122, 132, 142, 152, and 162 (see FIGS. 1A-1F). In other embodiments, the toolset windows 112, 122, 132, 142, 152, and 162 may be in other locations. One of these tools is a window that is automatically filled with data about the collection of data, a selected subset, or an individual dataset. For example, if a user is looking at the entire collection of data, the toolset window may list the total number of documents and may provide for the ability to highlight and show/hide categories of data, such as hiding all videos, for example. If a subset has been selected, the toolset window may display information on the number of documents in the subset, the theme of the subset, the date range of the dataset within the subset, and other information relevant to the subset. Manually filling in one of the fields in the information toolset window allows a user to search the selected set of documents for a desired piece of information. For example, if a subset of 1000 emails is selected, entering a particular name in the sender box of the toolset window may cause all icons with that sender to be highlighted in one color and all icons where that person is a recipient to be highlighted in another color.

A toolset may be pulled from its location and attached to an icon as part of a subset, as if attaching a sticky note to the top of a folder. As the user peels the top level toolset window containing all the information in a given subset, a copy of the window may take its place, as if a sticky note was peeled off the top of a stack and its duplicate was underneath. In this manner, comments created about a dataset or subset may be easily made and reviewed without having to reopen and go through the same dataset or subset again. This allows for top-level information to be easily shared between users going through different subsets.

In an embodiment, data may be extracted, and the extracted data and the associated metadata may be made available in other programs, such as word-processing programs for example. According to an embodiment, an icon can be clicked, held, and dragged into a document, creating a link to the selected icon. A toolset allows for embedding data from that link into a document, as the document is being written.

In an embodiment, the dataset or subsets thereof being represented in the 3D representation may be available to one or more users at a time. Additionally, according to another embodiment, subsets of data may be saved and later accessible for viewing, manipulation, etc.

Data Input

FIG. 2 provides a data input flowchart 200. Datasets may come from a variety of sources, including but not limited to coding data (.csv, .oll), pre-existing databases (.mdb), .pdf files, image files (.tif, .png, .bmp, etc.), video files, streamed video files (.mpg, .mov), and email databases (.msg, .pst, etc.). Individual datasets 204 or groups of datasets 202 may be dragged and dropped directly into the main window for processing and incorporation into the 3D representation. In other embodiments, individual datasets 204 or groups of datasets 202 may be incorporated into the 3D representation by other means, such as, for example, selection through another window or program.

The data representation program provided herein, according to some embodiments, determines if multiple datasets or one dataset is dragged in or otherwise provided. At 206 of the flowchart 200, for each dataset, the program determines whether the dataset is an image-based file or a data-based document.

If the dataset is a data-based document, at 208 the text of the dataset is parsed (further described below).

In some embodiments, each input (i.e., dataset) is searched to determine attached or associated metadata, such as time, date, author, etc. If there is no pre-coded metadata, in some embodiments, the program attempts to create metadata, for instance through OCR-ing the dataset if the dataset is an image, or analyzing text if the dataset is a text file. In cases where the program cannot determine any information, it may prompt the user to supply it.

If the dataset is an image, at 210 the program determines whether there is OCR information associated with the file. If the image has OCR data associated with it (embedded or in a separate file), it will go to the next stage at 208, parsing the text. OCR is a method of digitizing images of, for example, scanned or hand-written text, into computer-readable text. Although embodiments herein are described with respect to OCR methods and data, the invention is not so limited and other types of image conversion and data extraction may be utilized.

If a dataset does not have OCR information, at 212 the program will extract individual pages (if more than one page exists in the dataset), at 214 run an OCR routine (or the like routine), and at 216 search for a readable date. If the program finds a date, it will go to the next stage at 208, parsing the text.

If the program does not find a readable date, at 218 it asks the user to manually enter a date. Then the program will go to the next stage at 208, parsing the text.

The program parses the text (208) to extract information to populate the data fields including, but not limited to, date created, authors, recipients, body text, cc's, etc. If the dataset is a string of emails, the program divides the document into the component emails, assigns a “chainID” to the chain, and assigns an “emailID” to the component emails. They may, according to an embodiment, be added individually to the database based on time sent.

In some embodiments, the data representation program may use this generated information to determine whether the dataset is a duplicate of other documents already in the program. If the dataset is a duplicate, it may determine whether a component email is part of the original chain or referenced separately. In an embodiment, duplicate emails will be noted and saved, but may not be displayed. “Copied” emails may be added to the window, since they may be regarded as parts of separate chains.

The next step at 220, according to some embodiments, is to create a new instance of an appropriate class in an array which will retain the extracted information. At 222, existing database metadata may be inputted to create the new class instance. At 224, the new class instance may be added to a database.

The program then, according to an embodiment, at 226 creates a new icon and uses the date information to place the icon in a unique spot in the 3D representation. At 228 appropriate methods are associated with the icon to allow for interactivity with the icon as discussed above and described in detail below, in accordance with various embodiments.

User Interaction

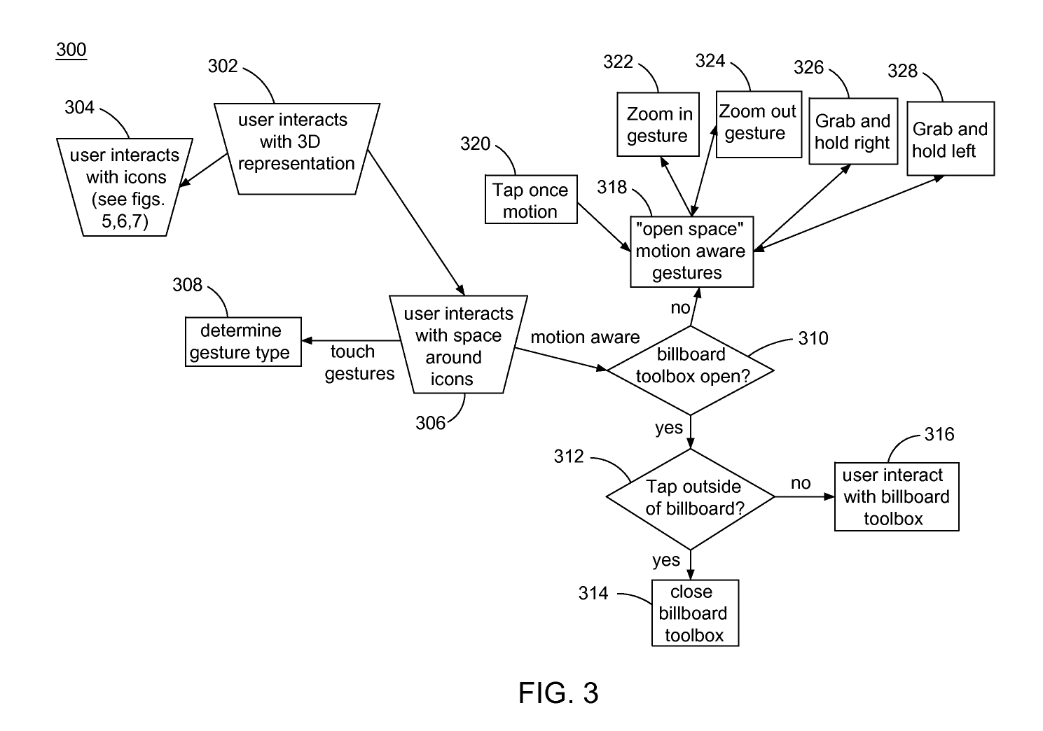

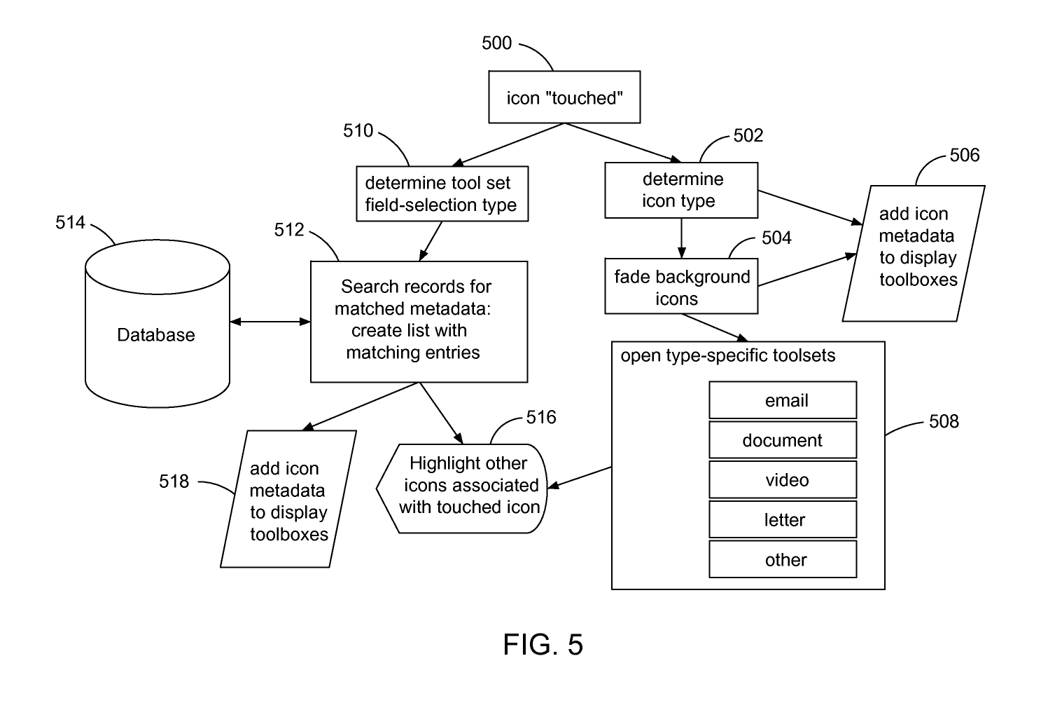

FIG. 3 provides a flowchart 300 illustrating user interaction features of the data representation program. At 302 it is determined that a user is interacting with the 3D representation in a window. The data representation program determines whether a touch is on an icon or on the space between icons. 304 of the flowchart 300 indicates that a user is interacting with one or more icons. Interactions on an icon are described below with reference to FIGS. 5, 6, and 7.

If a user interacts with space around the icons (306), the program determines what type of gesture is received, such as a touch gesture (308) or a motion-aware gesture. For a motion-aware gesture, at 310 a determination is made as to whether a billboard toolbox is opened. If a billboard toolbox is opened (310), then at 312 a determination is made as to whether the motion-aware gesture is with respect to the billboard toolbox. If the gesture is outside of the billboard toolbox, then at 314 the billboard toolbox is closed. If the gesture is not outside of the billboard toolbox, then at 316 user interaction with the billboard toolbox is implemented by the data representation program.

If a toolbox is not opened (310), then at 318 the data representation program monitors for open space motion aware gestures. A “tap once” gesture (320) results in the de-selection of all boxes or icons. A “zoom in” gesture (322) moves the camera forward. As the camera moves, it checks the zoom level and simultaneously or near simultaneously checks to see if the camera is in an atmosphere (i.e., within a set distance of an icon or group of icons). A “zoom out” gesture (324) will move the camera back, while still checking zoom level and atmosphere. “Grab and hold right” (326) and “Grab and hold left” (328) gestures move the 3D representation right or left, respectively, while checking for zoom levels and atmosphere.

The zoom level and atmosphere detection combine to determine what tool sets populate the screen. The flowchart 400 of FIG. 4 represents detecting a change in camera position and, if conditions are met, changing the toolsets and level of detail in the 3D representation, according to an embodiment.

At 410, the data representation program checks camera location. At 420, a determination is made as to whether the camera is within a specified distance of an icon and if that icon is also in front of the camera. If so, at 430 the data representation program begins icon interaction, described below with reference to FIGS. 5, 6, and 7. In an embodiment, a specified distance may be measured in units to an icon (such as, for example, within 10 units of an icon). In an embodiment, the icon is determined to be in front of the camera if the icon is within a 45° cone of the front of the camera. Other variables and parameters may be utilized to indicate camera location.

If both conditions are not met, at 440, a determination is made as to whether any icon or subset of icons is selected. If so, at 450 the view preferences, either default or user-modified, are applied. View preferences include, but are not limited to, the distance away from the camera at which icons are still present, the size of the icons on the screen, etc. The data representation program also, according to an embodiment, condenses icons past a default or user-specified zoom level. Condensing icons entails, in one embodiment, taking all of the icons from a specific day and making one, larger visible box. Alternatively, in another embodiment, all the icons in a month may be aggregated into one larger box, and further all icons in a year may be aggregated. They may, according to an embodiment, remain aggregated until the camera gets closer to the box, at which time, the one larger box may be replaced by individual boxes or icons.

If no icons are selected (440) and/or once the view preferences are applied (450), then at 460 the data representation program replaces the toolsets with more appropriate toolsets based on, for example, the zoom level. The program may not, according to an embodiment, replace toolsets if a subset is currently open.

Icon Touched

When an icon is touched, as represented in the “icon touched” flowchart 500 of FIG. 5, at 502 the data representation program determines the type of icon touched and at 510 may determine the type of field currently selected in the search toolset.

According to an embodiment, after the icon type determination (502), at 504 the data representation program may fade the background of non-selected icons. Following 502 or 504, at 506 the data representation program may, according to an embodiment, obtain the metadata from the selected icon and use that information to populate the fields in a display toolbox toolset. At 508, the data representation program may run the type-specific toolsets particular to the selected icon. For instance, an email toolset may include opening display toolboxes that list all of the metadata particular to emails. It may also include opening a window inside the icon that shows the page image of that particular email. It may also show the emails in the string above and below the selected email. When emails above or below are viewed, their associated icons may be highlighted in the main window. Video-specific toolsets may include a window that shows the video with tools for playing, scrubbing, editing, and allowing clips to be created and saved in separate folders, clips to be emailed or attached to other icons in the collection of data, and the like, for example.

At 516, in an additional embodiment, the data representation program may also highlight other icons associated with the touched icons throughout the collection of data or a subset of data.

Additionally, as noted above, at 510, the search toolset selection type (e.g., sender, recipient, subject, etc.) may be determined. At 512, the program may, in some embodiments, search an associated database (514) for records that match the selected icon's metadata in that field and create or otherwise determine a list with those matching entries. The program may then use that list to highlight those icons with matching criteria in the 3D representation (516) and add data (i.e., icon metadata) to display toolboxes (518).

Icon Grabbed

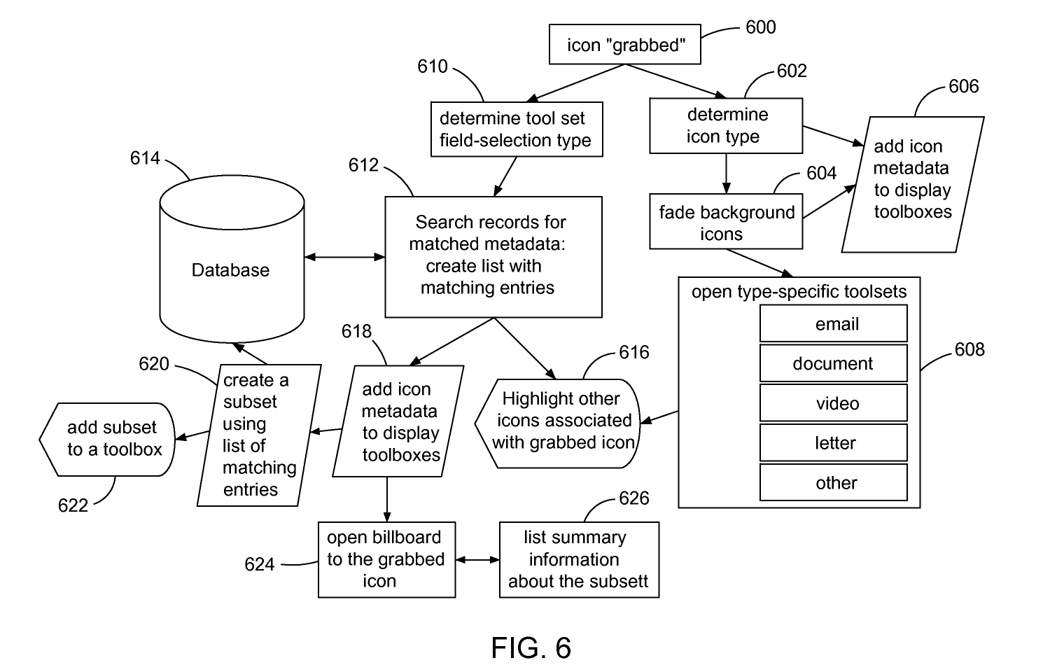

When an icon is grabbed, as represented in the “icon grabbed” flowchart 600 of FIG. 6, the data representation program may do all or a portion of the actions associated with an icon being “touched” as described above with reference to FIG. 5. According to an embodiment, at 620 the data representation program may also create a subset using the list of matching database entries, adding and saving that collection to the database as a subset (614). At 622, the subset of data may be added to a toolbox toolset listing subsets. According to an embodiment, at 624, the data representation program may additionally open a billboard to the grabbed icon, listing summary information about the data in the subset (626).

Icon Dragged

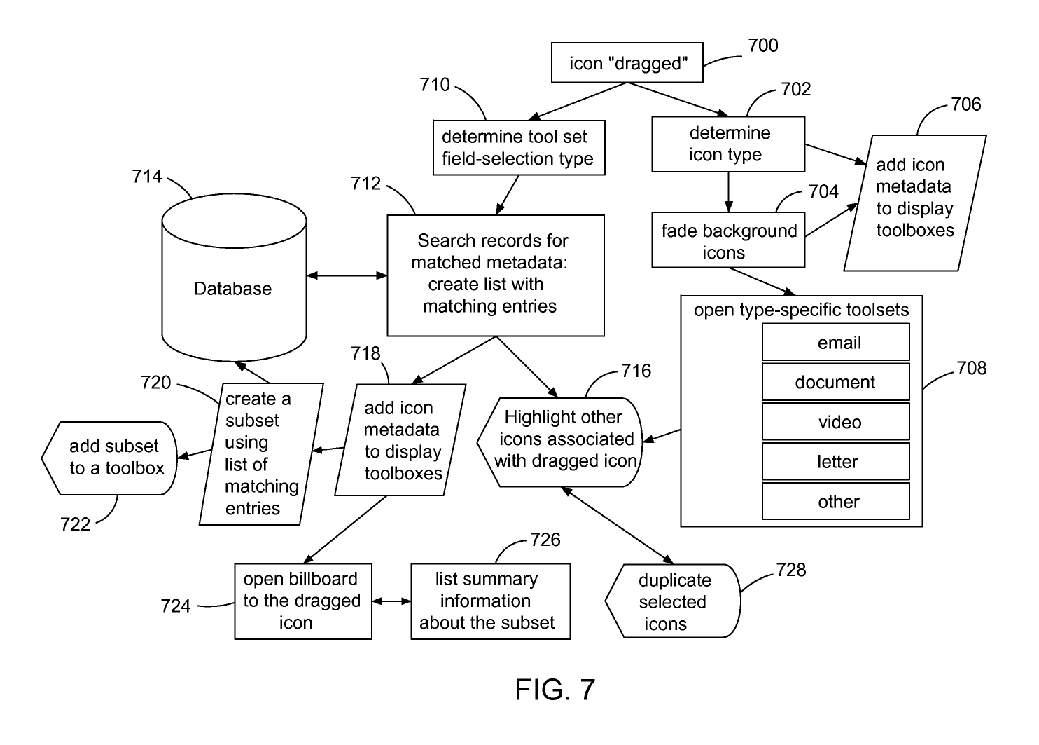

When an icon is dragged, as represented in the “icon dragged” flowchart 700 of FIG. 7, the data representation program may do all or a portion of the actions associated with an icon being “grabbed” as described above. Additionally, according to another embodiment, at 728 duplicate set of icons may be created, allowing the user to drag those icons to a separate section of the 3D representation. The dataset in that subset may be manipulated separately from the main collection of data.

According to an embodiment, context-based file associations may be created. Dragging an icon creates an icon representing a link to the data represented by the icon. Dragging that icon onto another icon or dataset associates or links together those pieces of data. For example, dragging an icon representing a video into an icon representing a transcript links those two together. When one set of data is viewed by a user, a section of the interactive toolset may, according to an embodiment, include a link to the video.

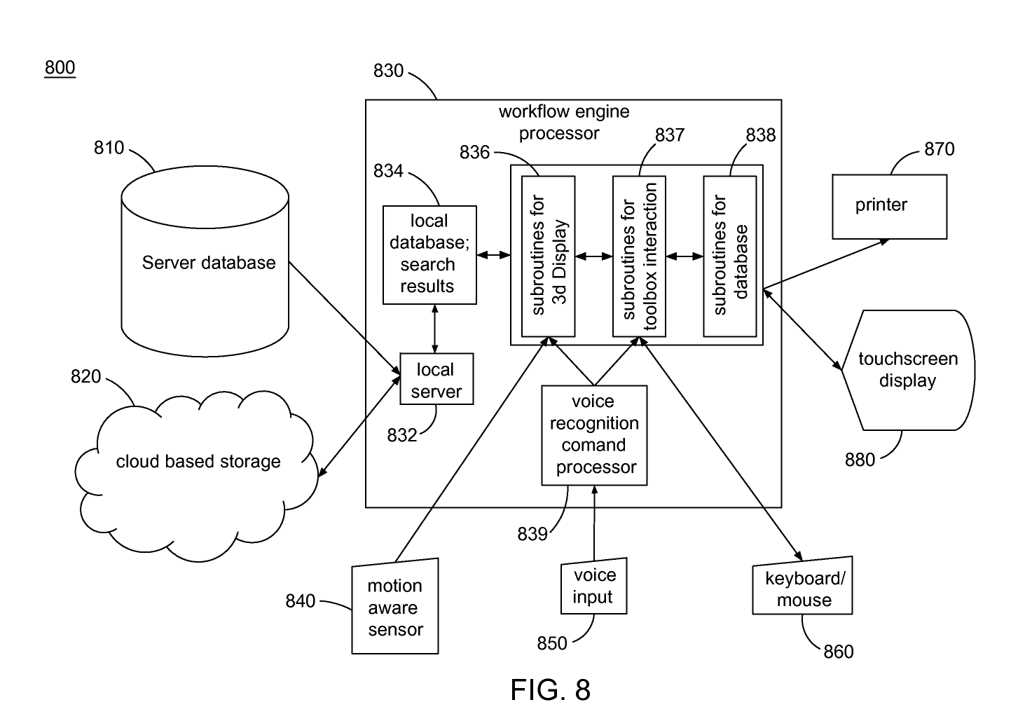

FIG. 8 provides an exemplary computing environment 800 for processing the actions associated with the data representation program. Included is a server database 810, which may include one or more subsets of data; the datasets may be contained on the server database, and separate subsets of data may be created for various subsets. A cloud-based storage 820 may also be provided, also containing, in some embodiments, separate subsets of data; the datasets may be stored on the cloud-based storage 820.

A workflow engine processor 830 includes a local server 832 for handling data requests between the server database and/or cloud-based storage and a local database 834, which stores datasets as needed. The workflow engine processor 830 also includes subroutines 836, 837, and 838 for implementing the 3D representation of the data, the toolbox and icon interactions, and the database requests. A voice recognition command processor 839 is provided to implement verbal commands. The workflow engine processor 830 interfaces with a motion-aware sensor 840, a voice input 850, and a keyboard/mouse 860 for receiving user-based commands to the 3D representation. The workflow engine processor 830 also interfaces with a printer 870 (to print data, images, etc.) and a touchscreen display 880 (to display the 3D representation). In other embodiments, the workflow engine processor 830 interfaces with other types of displays (standard computing monitors and the like).

The data representation program described herein allows users to visualize thousands of datasets at the same time by graphically depicting relationships among the documents. The program also provides for user interaction with the datasets in real-time. A user may zoom into a specific period of time, or show how a master draft agreement, for example, went through changes until it was signed by the various parties. Video depositions may be represented by an icon, clicked on and played, dragged into a subset, have clips made, and comments annotated. These actions may be done without using a keyboard or mouse, although they may also be done with either or both a keyboard and mouse. When motion-aware technology is used, an entire database may be accessed and manipulated using gestures made in the air. In combination with a speech-recognition program, a user may open a case, select a subset of files by grabbing and dragging the icons, then annotate them using the voice-recognition software, all without ever touching a mouse, keyboard, or screen.

Although the present invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

We claim:

1. A method of managing data in a database, the method comprising:
obtaining by a processor from one or more databases a collection of data comprised of a plurality of datasets;
storing by the processor the plurality of datasets in a local database;
associating by the processor each of the plurality of datasets with one or more metadata fields;
sorting by the processor a subset of the collection of data by ordering corresponding ones of the plurality of datasets according to at least one of the one or more metadata fields;
providing on a display by the processor a representation of the subset of the collection of data based on the ordering of the corresponding ones of the plurality of datasets, wherein the representation comprises a three-dimensional representation, wherein each of the corresponding ones of the plurality of datasets is represented by an icon in the representation; and
providing on the display by the processor an altered representation of the subset of the collection of data based on received user-based commands to the representation.

2. The method of claim 1, wherein the subset of the collection of data is selected based upon at least one of (i) a selected one or more of the plurality of datasets; and (ii) a selected one or more of the one or more metadata fields.

3. The method of claim 1, wherein the three-dimensional representation comprises a time and date-ordered grid of the icons of the corresponding ones of the plurality of datasets.

4. The method of claim 3, wherein the time and date-ordered grid comprises a calendar view of the icons of the corresponding ones of the plurality of datasets.

5. The method of claim 1, wherein the user-based commands comprise an action to one or more of move, rotate, resize, and zoom the representation to provide the altered representation.

6. The method of claim 5, wherein the action comprises one or more of a gesture command, a voice command, a touch command, a mouse command, and a keyboard command.

7. The method of claim 1, wherein the metadata fields comprise one or more of time, date, author, subject, and identification number.

8. The method of claim 1, wherein the icons are interactive, wherein interaction with a particular icon provides one or more of additional information and an additional representation associated with the particular icon to be provided.

9. The method of claim 1, further comprising:
providing on the display by the processor one or more toolsets within a portion of at least one of the representation and the altered representation, the one or more toolsets providing information and actions associated with at least one of the subset of the collection of data and the user-based commands.

10. A method of providing a time-ordered representation of data in a database, the method comprising:
obtaining by a processor from one or more databases a collection of data comprised of a plurality of datasets;
storing the plurality of datasets in a local database;
associating by the processor each of the plurality of datasets with an associated time field;
sorting by the processor a subset of the collection of data by ordering corresponding ones of the plurality of datasets according to the associated time fields; and
providing on a display by the processor a three-dimensional time and date-ordered representation of the subset of the collection of data based on the ordering of the corresponding ones of the plurality of datasets, wherein each of the corresponding ones of the plurality of datasets is represented by an icon in the representation.

11. The method of claim 10, further comprising:
providing on the display by the processor an altered representation of the subset of the collection of data based on received user-based commands to the representation.

12. The method of claim 11, wherein one or more of the time and date-ordered representation and the altered representation comprises a calendar view of the icons of the corresponding ones of the plurality of datasets.

13. The method of claim 11, wherein the user-based commands comprise an action to one or more of move, rotate, resize, and zoom the time and date-ordered representation to provide the altered representation.

14. The method of claim 13, wherein the action comprises one or more of a gesture command, a voice command, a touch command, a mouse command, and a keyboard command.

15. The method of claim 11, further comprising:
providing on the display by the processor one or more toolsets within a portion of at least one of the time and date-ordered representation and the altered representation, the one or more toolsets providing information and actions associated with at least one of the subset of the collection of data and the user-based commands.

16. The method of claim 10, wherein the icons are interactive, wherein interaction with a particular icon provides one or more of additional information and an additional representation associated with the particular icon to be provided.
